(19) United States
(12) Patent Application Publication
(10) Pub. No.: US 2025/0043843 A1
(43) Pub. Date: Feb. 6, 2025

(54) PLANE TORSION SPRING FOR A SERIES-ELASTIC ACTUATOR

(71) Applicant: Maxon International AG, Sachseln (CH)

(72) Inventor: Max Erick BUSSE-GRAWITZ, Alpnach Dorf (CH)

(21) Appl. No.: 18/719,078

(22) PCT Filed: Dec. 23, 2022
(86) PCT No.: PCT/EP2022/087770

§ 371 Date: Jun. 12, 2024

(30) Foreign Application Priority Data
Dec. 23, 2021 (EP) 21217540.0

(51) Int. Cl. F16F 3/02; F16H 19/08

(52) U.S. Cl. CPC F16F 3/023; F16F 2224/0208; F16F 2226/04; F16F 2230/0005; F16F 2238/024; F16H 19/08; F16H 2019/085

(57) ABSTRACT

The plane torsion spring has an inner fastening point, at least two outer fastening points, and at least two spring arms. Each of the at least two spring arms connects the inner fastening point to one of the outer fastening points in a spring-elastic manner. The spring arms have a similar contour and extend symmetrically, preferably point-symmetrically, with respect to the inner fastening point. The spring arms of the plane torsion spring have an S-shaped profile.

### CROSS-REFERENCE TO RELATED APPLICATIONS

This application claims priority to and the benefit of PCT Patent Application No. PCT/EP2022/087770, filed on Dec. 23, 2022, entitled “PLANAR TORSION SPRING FOR A SERIES-ELASTIC ACTUATOR,” and to European Patent Application No. 21217540.0, filed on Dec. 23, 2021, and entitled “PLANAR TORSION SPRING FOR A SERIES-ELASTIC ACTUATOR,” the entire contents of these two applications are herein incorporated by reference.

### BACKGROUND

### 1. Field

The present disclosure relates to a plane torsion spring, in particular for a series-elastic actuator, having an inner fastening point, at least two outer fastening points and at least two spring arms, each of which connects the inner fastening point to one of the outer fastening points in a spring-elastic manner, the spring arms having a similar contour and extending symmetrically, preferably point-symmetrically, with respect to the inner fastening point. Furthermore, the present disclosure relates to a series-elastic actuator with such a plane torsion spring and to a manufacturing method for a plane torsion spring.

### 2. Related Art

Series-elastic actuators with a plane torsion spring are used, for example, in robot applications to elastically connect a robot arm to the base body and drive the robot arm. Robot applications in industry accomplish a variety of tasks involving the movement and positioning of different objects. A common industrial robot for automated production may have one or more arms equipped with grippers to pick up, transport and position objects. An important mechanical requirement for such an industrial robot is to generate large and precise forces and torques while keeping the control stable. These torques and forces are generated by electromechanical actuators, usually electric motors, which apply a high torque in response to an electrical control signal, which is either transmitted directly into a rotary motion or via a linear conversion element into a linear force.

Series-elastic actuators with a plane torsion spring are also used in exoskeletons or walking robots, for example. There are numerous other applications in which the torque generated by an actuator is to be transmitted. The plane torsion spring provides elasticity to the transmission, which can prevent or at least significantly reduce hard impacts on the mechanics of the actuator and the environment.

Simple stiff actuators can generate large forces in a robot joint from a small joint displacement and enable a high range of force transmission and precise position control. However, the stiffness of a conventional robot joint makes it difficult to control the forces. Due to the importance of force control in robotic joint drives, high stiffness is avoided in order to achieve better force control. A widely used option for this is to connect an elastic element in series with the actuator. Such a series-elastic actuator has improved force control compared to a rigid actuator, as a series-connected elastic element requires greater deformation to generate the required force. Furthermore, such an elastic element makes it possible to detect the force exerted via the position instead of specifying it directly via the control of the actuator, which improves the accuracy and stability of the drive and at the same time reduces noise.

When developing elastic elements for a series-elastic actuator of robot joints, in addition to the boundary condition of a constraint installation space, there is also the requirement to withstand a large number of movements and large applied torques without slipping or wandering, as well as to consider economical production. The size restrictions resulting from the dimensions of the actuator and the robot joint as well as the working environment, in conjunction with the mechanical requirements, must be regarded as a major challenge. In technology, essentially flat bending springs are known for this purpose, which are often also referred to as torsion springs, which are used as an elastic element in the small available installation space of a robot joint drive. DE 10 2009 056 671 A1, for example, shows such a robot joint with a flat torsion spring. The spring brackets disclosed therein are arranged in one direction of rotation. For each spring bracket, the first section is attached to the inner mounting segment at a different circumferential position than the position at which the second section is attached to the outer mounting segment. In addition to conventional spring steel, spring titanium in particular, but also composite materials with carbon and glass fibers, are used for such plane torsion springs. In addition to simple spring designs, specially optimized springs with special shapes and holes in less stressed parts are also used. An optimized design of a plane torsion spring is known, for example, from EP 3 121 472 A1. Depending on the material used, it is manufactured by bending, milling or eroding and polishing. The costs of these manufacturing processes are sometimes very high, particularly for materials with high rigidity, especially when subtractive manufacturing methods are used. Additive manufacturing of spring steel and spring titanium using sintering or printing processes requires expensive post-processing of the surfaces for smoothing and hardening. In addition, additively manufactured torsion springs in particular have problems at the connection point for force transmission, for example due to twisting of the pins or seizure of the mount, which creates additional hysteresis in the torque and a change in the torsion angle curve.

### SUMMARY

The present disclosure is therefore based on the task of providing an improved plane torsion spring for a series-elastic actuator, which enables improved strength and reproducible deflection at low cost.

This task is solved in a generic plane torsion spring in that the spring arms of the plane torsion spring have an S-shaped profile.

The special one-piece shape of the plane torsion spring according to the disclosure comprises at least two S-shaped spring arms with an identical shape and an arrangement symmetrical to the inner fastening point, i.e. an arrangement of the at least two S-shaped spring arms offset by 180° (or 360°/number of S-shaped spring arms) at the inner fastening point, or a symmetrical, preferably point-symmetrical design of the plane torsion spring to the center of the inner fastening point. The S-shaped spring arms each connect one of the outer fastening points to the inner fastening point in a spring-elastic manner, whereby the S-shaped spring arms have a similar contour. The S-shaped spring arms produce optimum spring properties for use in a series-elastic actuator. The strength and spring elasticity can be adjusted to the values required for use in a series-elastic actuator by shaping the plane torsion spring according to the disclosure. The essentially linear spring characteristic curve and the resulting reproducible deflection of the plane torsion spring is very high. This makes it possible to measure the torque on the series-elastic actuator based on the deflection of the plane torsion spring. Due to the S-shaped profile of the spring arm, mechanical stresses that arise during force transmission on the torsion spring are distributed evenly and optimally over the spring arm, so that no undesirable overloads or underloads result in parts or sections of the spring arm.

In a preferred embodiment, the torsion spring has two spring arms, even if the number of spring arms can vary. A higher number of spring arms increases the spring constant and thus reduces the torsional flexibility of the plane torsion spring. As the spring arms should be accommodated in the smallest possible volume, two spring arms have proven to be the optimum balance between spring elasticity and the required installation space. The symmetrical S-shaped structure of the plane torsion spring with two S-shaped spring arms running anti-parallel to the inner fastening point enables a maximum spring length in a minimum space without the torsion spring colliding with itself, with an essentially linear spring characteristic.

In a useful embodiment, a torsion spring centerline is provided that extends as a straight line through an outer fastening point and a center point of the torsion spring, wherein the S-shaped spring arms each have an inner arc adjacent to the inner fastening point and an outer arc adjacent to the outer fastening points, and wherein the length of the distance of the outer contour of the inner arc from the torsion spring centerline and the length of the distance of the outer contour of the outer arc from the torsion spring centerline differ by less than 20%, preferably less than 10%, and more preferably the two lengths of the distances are equal. In addition to optimizing the spring properties, the special design of the S-shaped spring arms provided at the inner fastening point can minimize a resulting radial movement of the spring when a tangential force is introduced, preferably to a resulting radial movement of less than 20% of the introduced tangential movement. The symmetrical design of the S-shaped spring arms creates a particularly linear character of the spring stiffness over a large torsion range of the plane torsion spring. Due to the S-shaped profile, mechanical stresses are evenly distributed in the spring arm and there are almost no or at least reduced stress peaks or stress changes in the spring arms.

A preferred embodiment provides for the S-shaped spring arms to have a first spring section tapering in width starting from a wide connection section adjacent to the inner fastening point, followed by a second spring section widening in width and followed by a third spring section tapering in width, the third spring sections being adjacent to the outer fastening points. This special shape of the S-shaped spring arms arranged at the inner fastening point enables a small diameter and a small thickness of the torsion spring with a maximum spring length in addition to the linear spring characteristic due to the spring arms running symmetrically to the inner fastening point, whereby the spring constant and the maximum continuous alternating torque of the torsion spring can be optimized. The optimum approach here is to generate a relatively high degree of softness with a small diameter of the torsion spring.

In a favorable manner, the extension of a centerline of the wide connection sections of the S-shaped spring arms can have an angle in the range of 35° to 55° at the point of intersection with a torsion spring centerline through an outer fastening point. Furthermore, the extension of a centerline of the third tapered spring sections adjacent to the outer fastening points can have an angle in the range of 80° to 100° at the point of intersection with the torsion spring centerline through an outer fastening point. The centerline is again the bisector of the contour of the S-shaped spring arms having the same distance to the outer contour. According to the angular course of the centerline, the S-shaped spring arms have a closed S-shape in which the centerline between the inner fastening point and the outer fastening points has an absolute angular change of more than 360°, preferably of at least 370°, in particular of at least 385°. This arrangement and this angle of the two S-shaped spring arms improves the spring geometry and leads to an improved spring constant and spring properties.

In a further preferred embodiment, spring sections which have a similar radial distance to the spring element center point as the outer fastening points have a smaller width, preferably the area with the smallest width is at the smallest radial distance to the outer fastening point. Optimal spring stiffness can be achieved by widening the spring sections that are at a short radial distance from the center of the plane torsion spring and tapering the width of the spring sections that are at a large radial distance from the center of the plane torsion spring. Spring sections that are at a larger radial distance from the center of the plane torsion spring than the outer fastening points should also have a spring section that widens in width in order to achieve optimum spring stiffness.

In a special embodiment, the plane torsion spring is manufactured using an injection molding process. In the injection molding process, a molded product can be produced with a high precision and reproducibility by injecting a liquid material under high pressure into a sealable mold. Due to the very smooth surface of the injection mold, a very good surface quality of the injection-molded plane torsion spring can be achieved, so that additional polishing of the surface can be omitted, and thus saving working time and production costs at the same time.

In another preferred embodiment, the plane torsion spring is made of an amorphous metal. Thereby the plane torsion spring may be manufactured in one piece. Such an amorphous metal, which is also called metallic glass, has an unusual amorphous atomic arrangement and is generally harder, more corrosion-resistant and stronger than ordinary metals, while the deformability is usually significantly lower. Accordingly, torsion springs made of an amorphous metal have a high spring stiffness and bending energy density, which is up to ten times higher than that of conventional titanium spring alloys (titanium grade 5), so that an optimally designed torsion spring can be produced that is up to ten times lighter and smaller.

In accordance with the technical properties of the amorphous metal, such one-piece plane torsion springs for series-elastic actuators have a very small hysteresis in the torque or torsion diagram and thus enable more precise force measurement and controllability of the series-elastic actuator or an associated drive system. Furthermore, the lower weight and smaller dimensions of a plane torsion spring made of amorphous metal enable lower inertia, less vibration and smaller dimensions of the entire system. Metallic glass or amorphous metal has so far only been produced in thin layers or thin ribbons, for example by means of centrifugal melting, as a change from natural crystallization to an amorphous crystallization structure requires rapid cooling of the initial melt in order to freeze the mobility of the atoms before they can assume their usual crystal arrangement. For most metal alloys, this requires very high cooling rates. As a great deal of heat has to be transported from the inside of the material to the outer surface when the metal alloy is cooled, only a certain material thickness can be achieved depending on the required cooling rate and the thermal conductivity, regardless of the ambient temperature. Accordingly, the technical use of amorphous metals has so far been limited to products that can be produced using simple mechanical processing steps from the thin strips and wires that could previously be produced using centrifugal casting.

The injection molding process for amorphous metal is similar to the plastic injection molding process. Since the injection mold can be cooled very quickly after the end of the injection process using integrated cooling channels and cooling systems as well as the high thermal conductivity of the material used for the mold, the achievable thickness of the torsion spring made of amorphous metal is essentially limited by the necessary cooling rate of the material for the formation of an amorphous atomic structure and the thermal conductivity of the material for removing the heat from the interior of the spring in the injection mold.

A practical variant provides for the S-shaped spring arms to have a varying thickness between the inner fastening point and the outer fastening point. In the injection molding process in particular, spring sections can not only have a varying material thickness in width, but also in thickness. This means that the spring properties of the plane torsion spring can be changed in three dimensions of material thickness, which opens up additional possibilities in the design of the plane torsion springs and in achieving technical spring properties.

In another preferred embodiment, the plane torsion spring has a constant thickness. A constant thickness facilitates better and uniform cooling of the melt, especially in an injection molding process, and thus enables the formation of the amorphous atomic arrangement in the plane torsion spring. The term constant thickness refers to the undisturbed surface of the S-shaped spring arms, measured in the area of the centerline of the spring arms, i.e. the contour bisectors of the spring arms with the same distance to the outer edges, without taking into account the decreasing thickness at the edge of the spring arms due to injection molding. Preferably, the inner fastening point could also have the same thickness as the S-shaped spring arms.

In a preferred embodiment, an upper side and/or a lower side of the S-shaped spring arm has an indentation. The indentation allows material to be saved. This reduces the weight and thus the inertia of the plane torsion spring. Furthermore, saving material also reduces material costs. In addition, the plane torsion spring can harden better and faster when manufactured as a cast part, especially in the core, or a sufficiently high cooling rate can be achieved in an injection molded part.

In a further preferred embodiment, one side surface of the S-shaped spring arm has a bulge. The bulge makes it easier to remove the S-shaped spring arm from an injection mold.

The inner fastening point can have an angular receptacle, preferably a square mount, for a secure torque input. Accordingly, one or more additional holes or receptacles for a torsion-proof fastening of the plane torsion spring via the inner fastening point can be dispensed with. The square mount can be rounded at the corners. The square mount enables the torques and forces to be transmitted to be introduced safely and therefore allows a low hysteresis in the torque or torsion diagram.

For safe installation and trouble-free force transmission, the outer fastening points can be rotatably pivoted, preferably by a needle bearing. Due to the rotatable bearing of the outer fastening points, the forces are optimally transferred to the plane torsion spring without causing major friction losses at a circular attachment eyelet. Due to their long and flat design, needle roller bearings are particularly suitable for absorbing large bearing forces in a small installation space. The circular attachment eyelets can have a greater thickness than the S-shaped spring arms, with one end face of the attachment eyelets being flush with one surface of the spring arms and the other end face projecting from the second surface of the spring arms. The circular attachment eyelets of the outer fastening points enable coupling with the driven component via axles mounted on needle bearings. In addition to decoupling the spring constant from the connection with the driven component, this results in low friction values, low heating and low effect on the hysteresis in the torque or torsion diagram, so that an overall better measurement accuracy can be achieved.

An expedient design provides for the plane torsion spring to be manufactured essentially post-processing-free. In this context, “essentially post-processing-free” means that there is no need for contour machining and large-scale polishing of the surface, which can save additional work steps, time and costs. However, during the production of the plane torsion spring in an injection molding process, sprue residues, mold seams and sharp edges may occur, which make corresponding smoothing, deburring and rounding necessary. Such work steps should not be covered by the term “essentially post-processing-free”, but should be assigned to the injection molding process. When manufacturing the plane torsion spring by means of an injection molding process, even complex geometries can be produced in series at low cost, as no eroding or milling and only a few additional injection molding-related work steps are necessary.

Furthermore, the present disclosure relates to a series-elastic actuator, preferably a robot joint actuator, with an electric drive and a plane torsion spring according to the embodiments described above. Such a series-elastic actuator according to the disclosure can also have a small size of the actuator itself with small dimensions of the plane torsion spring with a low inertia, less vibration, a more precise force measurement and an improved controllability of the system. At the same time, the overall manufacturing costs can be significantly reduced due to the elimination of post-processing steps in the production of the plane torsion spring made of amorphous metal and the smaller dimensions of the actuator itself. The electric drive can consist of an electric motor, preferably an ironless electric motor or an iron-core internal rotor motor, and a gearbox, preferably a planetary gearbox, an eccentric gearbox or a shaft gearbox.

In a favorable manner, the inner fastening point of the plane torsion spring can be fixedly coupled to the electric drive and the outer fastening points of the plane torsion spring can be rotatably coupled with respect to an actuated element. In particular for use as a robot joint actuator, it is advantageous to design the spring ends to be rotatable relative to the driven element via the outer fastening points in order to enable the lowest possible hysteresis in the torque or torsion diagram and thus high measuring accuracy and precise control.

Furthermore, the present disclosure relates to a manufacturing method for a plane torsion spring, in particular for a series-elastic actuator, according to one of the embodiments described above, the method comprising providing an injection mold for the plane torsion spring, injecting a material suitable for injection molding, preferably an amorphous metal alloy or a plastic material, into the injection mold, cooling the injection mold and the injection-molded plane torsion spring, removing the plane torsion spring made of amorphous metal from the injection mold, and optionally machining the plane torsion spring to remove sprue residues and injection-molded seams and to deburr and round off edges. Furthermore, the surfaces of the plane torsion spring that are subject to a demolding angle can optionally be straightened by machining the plane torsion spring so that the surfaces can serve as seats for a square mount or a bearing. The demolding angle serves to simplify the demolding of the plane torsion spring from the injection mold. The demolding angle prevents the plane torsion spring from tilting during demolding from the injection mold. In the areas that serve as seats for the bearing or the square, the surface can also be sufficiently straightened after demolding by fine machining, fine milling or reaming so that the surface can serve as a seat for the square mount or for a bearing, for example in a circular attachment eyelet in the outer attachment section.

Such a manufacturing process makes it possible to provide a plane torsion spring with small dimensions and low weight, a large spring constant and high stiffness. The use of a plane torsion spring manufactured in this way in a series-elastic actuator enables lower vibrations, more precise force measurement and improved controllability of the actuator while maintaining small dimensions and a lower weight. The amorphous metal alloy preferably consists of at least four elements with fundamentally different atomic sizes. The resulting crystal structure is a favorably formulated eutectic that allows cooling times of several seconds without triggering a recrystallization process, which makes it possible to produce a plane torsion spring from an amorphous metal in an injection molding process.

### BRIEF DESCRIPTION OF THE DRAWINGS

In the following, a non-limiting embodiment of the present disclosure is explained in more detail with reference to exemplary drawings. It shows:

FIG. 1 a block diagram of a series-elastic actuator according to the disclosure,

FIG. 2 a plan view of a plane torsion spring according to the disclosure for the series-elastic actuator of FIG. 1,

FIG. 3 a perspective view of the plane torsion spring of FIG. 2,

FIG. 4 a perspective side view of the plane torsion spring of FIG. 2,

FIG. 5 a top view of the plane torsion spring of FIG. 2 with a torsion spring centerline and a spring arm centerline,

FIG. 6 a perspective view of a plane torsion spring with varying thickness of the spring arms,

FIGS. 7A and 7B top views of other examples of a plane torsion spring,

FIGS. 8A and 8B sectional views of the S-shaped spring arm,

FIG. 9 a perspective view of a part of the S-shaped spring arm with varying cross-section,

FIG. 10 a perspective view of a part of the S-shaped spring arm with a further cross-section, and

FIG. 11 a further sectional view of the S-shaped spring arm.

### DETAILED DESCRIPTION OF THE ENABLING EMBODIMENTS

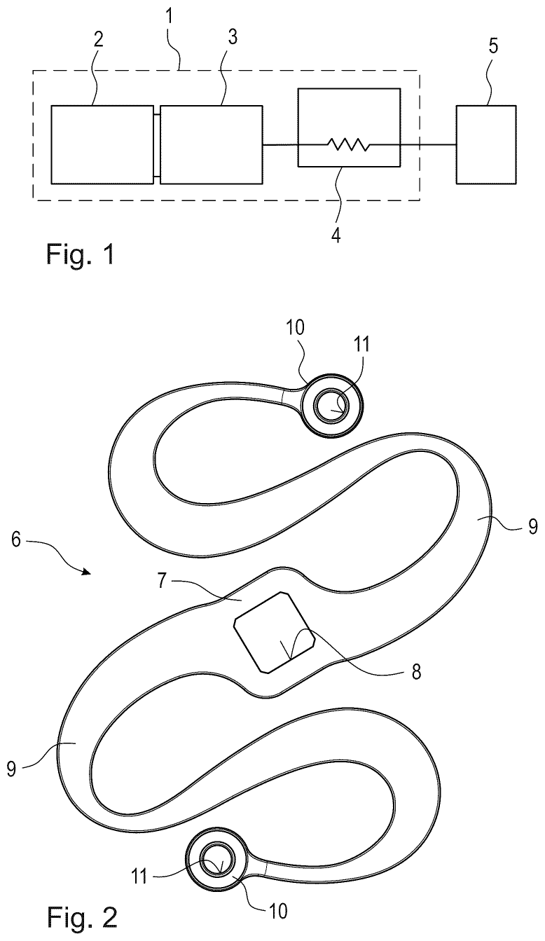

The block diagram in FIG. 1 illustrates the essential components of a series-elastic actuator 1 with a torque-generating unit, usually an electric motor 2, which is connected via a gearbox 3 and a spring element 4 to an actuated element 5, for example a robot arm, an exoskeleton or a walking robot. The gearbox 3 enables the use of a smaller electric motor 2, which is operated at higher speeds. The gearbox 3 can be an integral part of the electric motor 2 or be separate from it. An electric drive can comprise an electric motor 2 and also a gearbox 3. The gearbox 3 often reduces the speed of the electric motor 3, whereby the torque of the electric drive is increased in the same ratio. Ironless or slotless electric motors are often used as electric motor 2 due to their high dynamics. For example, a planetary gear, an eccentric gear or a shaft gear can be used as the gearbox 3. In this series-elastic actuator 1, a spring element 4 is coupled in series with the output of the gearbox 3 or, if no separate gearbox 3 is used, is connected directly to the electric motor 2. The element 5 to be actuated by the series-elastic actuator 1 is connected in series with the second side of the spring element 4. The spring element 4 introduces series-elasticity at the interface between the series-elastic actuator 1 and the actuated element 5, which enables precise control of the force exerted on the actuated element 5. Such series-elastic actuators 1 are used in large numbers in industrial robots as robot joint drives, in which large forces and torques must be transmitted precisely and permanently to the actuated element 5, i.e. the robot arm.

When used in industrial robots, the axial distance between the series-elastic actuator 1 and the actuated element 5 and additionally also the maximum length of the series-elastic actuator 1 can be narrowly limited, which in particular has an effect on the maximum length of the used spring element 4. Similarly, the radial diameter of the series-elastic actuator 1 can be severely restricted, which also limits the maximum diameter of the spring element 4. Accordingly, it is important to accommodate the rigidity required for the spring element 4 in a small installation space and at the same time ensure a sufficiently secure coupling of the spring element 4 with the gearbox 3 and the actuated element 5 in order to avoid slippage and thus hysteresis in the torque or torsional angle curve.

In the series-elastic actuator 1 shown in FIG. 2, a plane torsion spring 6 is used as spring element 4, wherein the spring arms 9 of which have an S-shaped profile. As can be seen in FIG. 2, the plane torsion spring 6 comprises an inner fastening point 7 with a square mount 8 rounded at the corners for receiving a square profile for coupling to the gearbox 3, two S-shaped spring arms 9, each of which has an identical contour and extends 180° offset and point-symmetrically to the inner fastening point 7, as well as two outer fastening points 10, which are connected to the outer ends of the S-shaped spring arms 9. The square mount 8 of the inner fastening section 7 enables slip-free coupling of the plane torsion spring 6 with the associated torque drive by an electric motor 2 or gearbox 3. The outer fastening points 10 are designed as circular attachment eyelets 11. Such attachment eyelets 11 enable the rotatable mounting, for example by arranging attachment axles with needle bearings (not shown) for low-friction coupling with the actuated element 5 in order to minimize heating due to friction and prevent effects on hysteresis, which improves the accuracy of the torque measurement.

The spring element 4 in an actuator 1 may preferably be two plane torsion springs 6 which preferably run in opposite directions. This prevents asymmetry in the deflection of the spring element 4 depending on the direction of rotation of the actuator 1. In addition, a preload of the plane torsion springs 6 can be generated between the square mount 8 and the outer fastening points of the plane torsion springs 6 arranged next to each other.

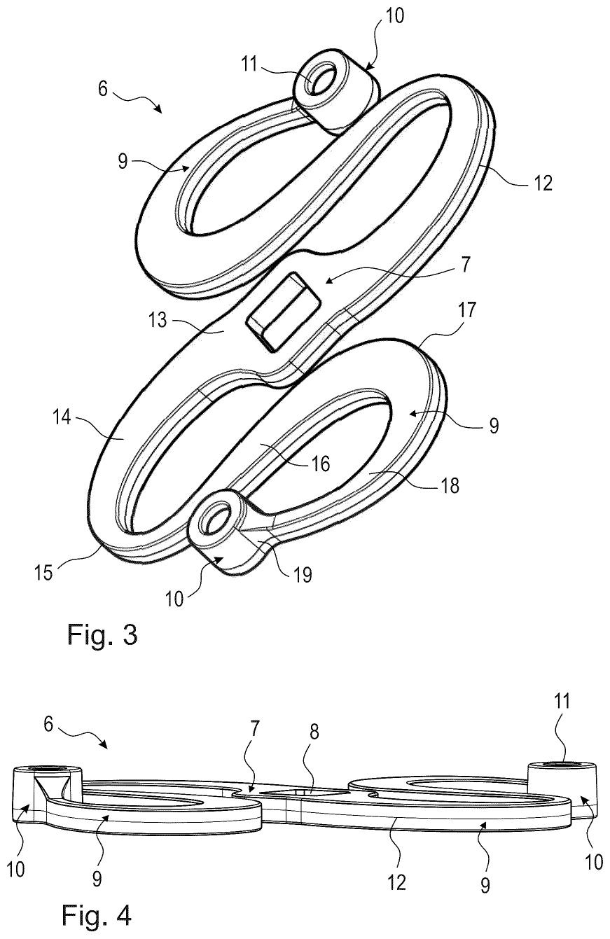

The perspective view of the plane torsion spring 6 in FIG. 3 and FIG. 4 shows a constant thickness of the two S-shaped spring arms 9 and the inner fastening section 7 of this plane torsion spring 6 manufactured, for example, from amorphous metal by means of an injection molding process. A circumferential mold seam 12 can be seen on the outer edges of the S-shaped spring arms 9, the inner fastening point 7 and the outer fastening points 10, which is created by the two-part mold used in the injection molding process. In contrast to the inner fastening points 7 and the S-shaped spring arms 9, the outer fastening points 10 have a significantly greater thickness, with the attachment eyelets 11 protruding only on the upper side of the plane torsion spring 6. As can be seen in the perspective side view in FIG. 4, the attachment eyelets 11 on the lower side of the plane torsion spring 6 are in one plane with the S-shaped spring arms 9 and the inner attachment section 7. This allows the two lower sides or rear sides of two plane torsion springs 6 to lie flat against each other.

The inner fastening points 10 and the outer fastening points 7 are more centered or point-shaped in relation to the other parts of the S-shaped spring arms, which are referred to as sections. However, the inner fastening points 10 and the outer fastening points 7 can also be understood as constructive sections and thus be referred to as inner fastening section and outer fastening section.

As can be clearly seen in FIG. 2 and FIG. 3, the plane torsion spring 6 can have two S-shaped spring arms 9 formed with a special contour. The two S-shaped spring arms 9 of a plane torsion spring 6 according to the present disclosure extend from the inner fastening point 7 in opposite directions offset by 180°. In this case, the S-shaped spring arms 9 extend from a wide connecting section 13 at the inner fastening point 7 into a first spring section 14 that tapers in width and extends into the area of the first inner arc 15 of the S-shaped spring arms 9. This first spring section 14, which tapers in width, is followed in the region of the inner arch 15 by a second spring section 16, which widens in width and extends into a second outer arch 17 of the S-shaped spring arms 9, where it merges into a third spring section 18, which tapers in width. The third spring section 18, which tapers in width, extends to a connecting section 19 to the attachment eyelets 11.

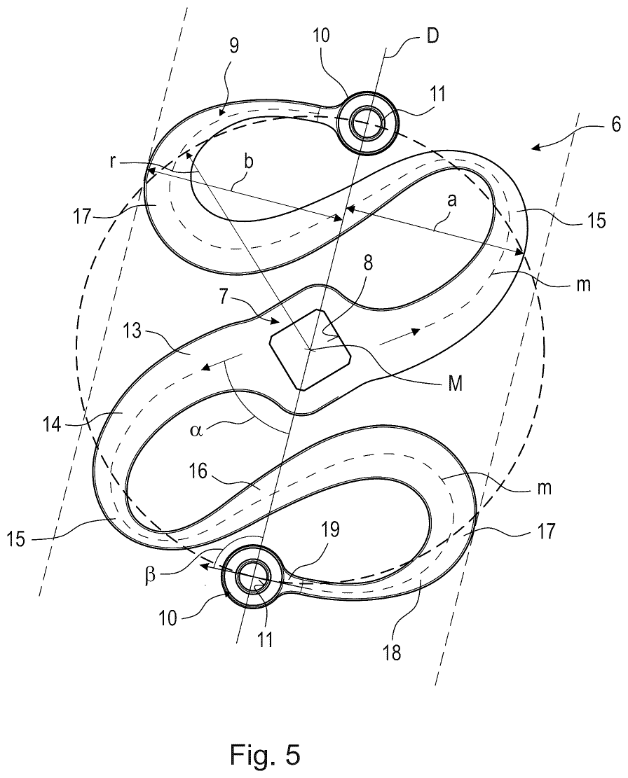

In the top view shown in FIG. 5 of the plane torsion spring 6 already shown in FIG. 2, in addition to the curved contour of the S-shaped spring arms 9, its centerline m is also drawn, a contour bisector on the surface of the S-shaped spring arms 9, which runs at the same distance from the outer contour of the S-shaped spring arms 9 between the inner fastening point 7 and the outer fastening points 10. Here again, the special contour of the S-shaped spring arms 9 can be clearly seen, which extends from the inner fastening point 7 and the adjacent wide connecting section 13, the first tapered spring section 14, the inner arch 15, the second widening spring section 16, the outer arch 17 and the third tapered spring section 18 as well as via the connecting section 19 to the outer fastening points 10. The extension of a centerline m of the wide connection section 13 at the intersection to a torsion spring centerline DM, which extends through the center point M of the inner fastening point 7 and the outer fastening point 10 of the attachment eyelet 11, has an angle α in the range of 35° to 55° to the torsion spring centerline DM. Furthermore, the end of the S-shaped spring arms 9 in the third spring section 18 has an angle β between the extension of a centerline m and the torsion spring centerline DM in the range of 80° to 100°. Accordingly, the contour of the S-shaped spring arms 9 forms a complete S-shape, in which the centerline m has an absolute angle change of over 360° in the course over the S-shaped spring arms 9. In the exemplary form of the plane torsion spring 6 according to the present disclosure shown in FIG. 5, the S-shaped spring arms 9 have an absolute angular change of over 400°.

The torsion spring centerline DM is a straight line that runs through the center point M and at least one outer fastening point 10. Depending on the arrangement of the S-shaped spring arms, the torsion spring centerline DM may also run through the center point M and two outer fastening points 10.

In addition to the complete S-shape, the S-shaped spring arms 9 of a plane torsion spring 6 according to the present disclosure also have an unusual progression of the width of the S-shaped spring arms 9 between the wide connecting section 13 and the tapering third spring section 18. This profile of the S-shaped spring arms 9, which can be characterized as thick-thin-thick-thin, in conjunction with the distances of the inner arch 15 and the outer arch 17 from the torsion spring centerline DM, permits the high linearity of the plane torsion spring 6 according to the present disclosure. Here, the length of the distance a of the outer contour of the inner arch 15 from the torsion spring centerline DM is preferably as large as the length of the distance b of the outer contour of the outer arch 17 from the torsion spring centerline DM. As can be seen in FIG. 5, in the embodiment of the plane torsion spring 6 shown here, the distance b of the outer contour of the outer arches 17 to the torsion spring centerline DM is less than 20%, preferably less than 10%, greater than the distance a of the outer contour of the inner arches 15 relative to the torsion spring centerline DM.

From the center point M of the plane torsion spring 6 to the circular attachment eyelet 11, the S-shaped spring arm 9 consists of several sections. The wide connecting section 13 is followed by the first spring section 14, the inner arc 15, the second spring section 16, the outer arc 17 and finally the third spring section 18. A circle with the center at the center point M of the plane torsion spring 6 and a radius corresponding to the distance r between the center point M and the outer fastening point 10 can be drawn on the plane torsion spring 6. Sections of the S-shaped spring arms 9 that are close to the circle have a smaller width than sections that are further away from the circle. This applies to areas of the S-shaped spring arm sections that lie inside the circle and to areas of the S-shaped spring arm sections that lie outside the circle.

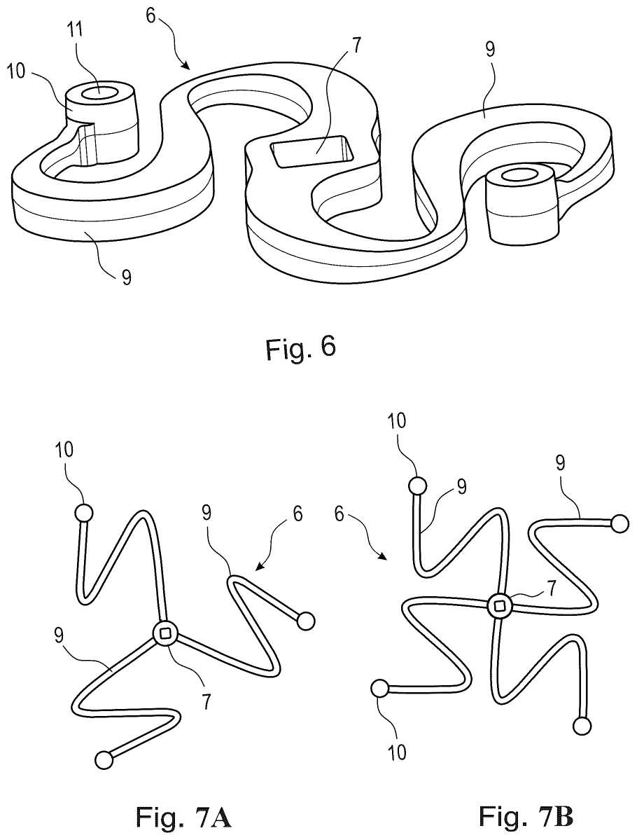

FIG. 6 shows a plane torsion spring 6 with S-shaped spring arms 9, whereby the S-shaped spring arms 6 have a varying thickness between the inner fastening point 7 and the outer fastening point 10. Due to the varying thickness of the different sections of the S-shaped spring arms 6, the spring-elastic properties of the S-shaped spring arms 6 can be adjusted not only by changing the width, but also by changing the thickness. This enables additional options in the design of the plane torsion spring 6. Particularly in the case of parts produced by injection molding, it is possible to define the shape of the injection mold and thus the shape of the component produced therein in three dimensions. If two plane torsion springs 6 are arranged in an actuator 1 as described, the varying thickness should be on the side facing away from the second plane torsion spring 6. It is also possible, for example, to provide a spacer cam for mutual interference between the two plane torsion springs 6.

FIGS. 7A and 7B show further embodiments of plane torsion springs 6. The plane torsion spring 6 in FIG. 7A has three S-shaped spring arms 9, while the plane torsion spring 6 in FIG. 7B has four S-shaped spring arms 9. Plane torsion springs 6 with five or more S-shaped spring arms 9 are also possible. However, it should be noted that the greater the number of S-shaped spring arms 9, the greater the risk of collision between the S-shaped spring arms 9 when twisting the plane torsion springs 6.

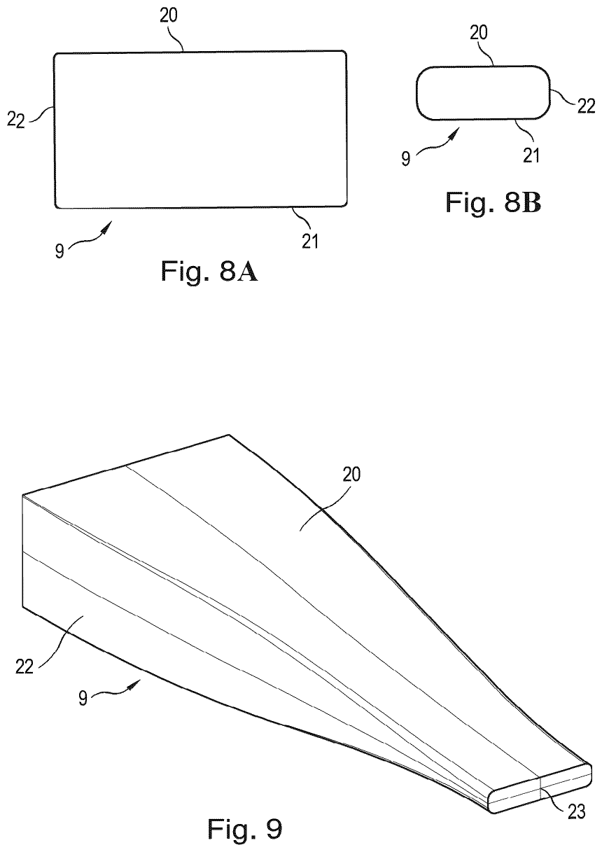

FIGS. 8A and 8B show different sectional views of the S-shaped spring arm 9 of a plane torsion spring 6. The S-shaped spring arm 9 has an upper side 20 and a lower side 21. The other two surfaces, that connect the upper side with the lower side 21, form the side surfaces 22. As shown in FIG. 6, the width and thickness and thus the cross-section of the S-shaped spring arm 9 can vary. In FIG. 8A, the corners of the approximately square cross-section of the S-shaped spring arm 9 are only slightly rounded. In FIG. 8B, the corners of the approximately square cross-section of the S-shaped spring arm 9 are significantly more rounded. By rounding the corners, for example, fatigue fractures of the S-shaped spring arm 9 can be reduced.

FIG. 9 shows a perspective view of a part of the S-shaped spring arm 9 with a varying cross-section. The cross-section tapers towards the lower right end, and thus towards the perspective near end in FIG. 9, and increases towards the upper right or towards the perspective end of the section of the S-shaped spring arm 9. In order to illustrate the expansion of the cross-section, additional auxiliary lines are drawn in the middle of the outer surfaces of the S-shaped spring arm 9. The auxiliary lines are drawn on the upper side 20 and on the side surface 22 of the S-shaped spring arm 9. The corners of the approximately square cross-section of the S-shaped spring arm 9 are rounded to varying degrees depending on the cross-section. The rounding of the corners can depend on the bending load requirements.

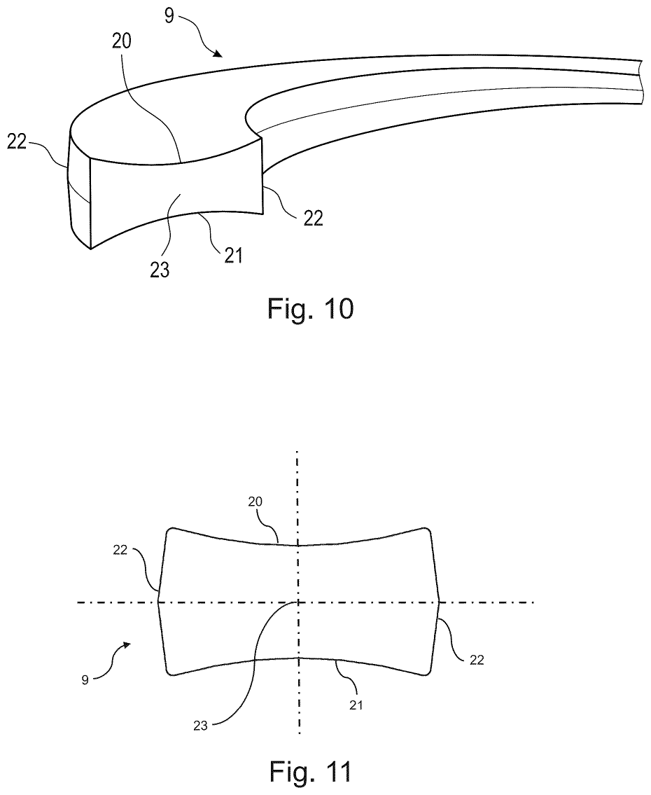

FIG. 10 shows a perspective view of a part of a section of the S-shaped spring arm 9 with a further cross-section. The cross-section of the S-shaped spring arm 9 is optimized for the spring-elastic load and for the weight of the S-shaped spring arm 9. The upper side 20 of the S-shaped spring arm 9 and the lower side 21 of the S-shaped spring arm 9 have an indentation towards the center 23 of the cross-sectional area of the S-shaped spring arm 9, or are bent through towards the center 23. This results in an M-shaped cross-section for the upper side 20, while the lower side is remotely reminiscent of a W-shape. The height of the cross-section is greatest on the side surfaces 22 of the S-shaped spring arm 9, while the height of the cross-section and therefore the thickness of the S-shaped spring arm 9 is lowest towards the center. The cross-section may remotely resemble a double-T beam. The cross-section prevents premature fatigue and thus fatigue fractures of the S-shaped spring arm 9. In addition, by reducing the height of the cross-section or by reducing the thickness of the S-shaped spring arm 9 towards the center, material is saved and thus the weight of the plane torsion spring 9 is reduced.

FIG. 11 shows the sectional view from FIG. 10 with pronounced bulges in the side surfaces 22 of the S-shaped spring arm 9. The bulges on the side surfaces 22 slightly change the width of the S-shaped spring arm 9. The bulges are caused by a demolding angle which surfaces on the injection-molded components should have in the demolding direction. The demolding angle, which can be between 0.1° and 10°, allows the injection molded component to be removed from the injection mold more easily and without tilting. In an injection mold with similar half shells that have the same demolding angle, the largest bulge of the side surface 22 is in the middle of the side surface 22. Surfaces that have a demolding angle can be straightened by finishing. As shown in FIG. 10, the upper side 20 and the lower side 21 have an indentation which runs in a rounded shape. The indentations have a slight incline in the middle and are relatively flat. The gradient increases towards the side surfaces 22.

In contrast to conventional products made of amorphous metal, which are first produced as thin layers or strips and then further processed, the plane torsion spring 6 according to the present disclosure is produced using a special injection molding process that enables high precision and reproducibility. Such an injection molding process makes it possible to realize the complex geometry of the plane torsion spring 6 according to the present disclosure and to produce it cost-effectively in series production without the need for contour machining or polishing of the surface. Depending on the design of the injection mold, such an injection molding process only requires deburring and rounding of sprue residues, mold seams and edges. Necessary for the implementation of such an injection molding process is the provision of a suitable injection mold for the plane torsion spring 6, which not only has a cavity for shaping the plane torsion spring 6, but is also made of a material with good thermal conductivity and has corresponding cooling channels and cooling devices in order to achieve the high cooling rate necessary for the amorphous solidification of the metal alloy. After the amorphous metal alloy has been injected into the injection mold, which has been heated to the temperature of the metal alloy, the next step is to rapidly cool the injection mold with the plane torsion spring 6 injected into it before the solidified plane torsion spring 6 made of amorphous metal can be removed from the injection mold. Typically, the injection mold consists of at least two halves that are pressed together for the injection molding process, but allow easy removal of the solidified plane torsion spring 6. The interface between the two halves of the injection mold can usually be identified by the mold seams 12 on the injection-molded plane torsion spring 6.

Instead of amorphous metal, the plane torsion spring 6 can also be made of another material suitable for injection molding, such as plastic or ceramic. Plastic has the advantage that it has a lower weight and can be procured and processed at low cost. Advantageously, the injection-molded material has good spring-elastic properties, whether due to a base material with high elasticity or the addition of suitable components such as glass or carbon fibers.

### LIST OF REFERENCE NUMERALS

1 Actuator
2 Electric motor
3 Gearbox
4 Spring element
5 Actuated element
6 Plane torsion spring
7 Inner fastening point
8 Square mount
9 S-shaped spring arm
10 Outer fastening point
11 Circular attachment eyelet
12 Mold seam
13 Wide connection section
14 First spring section
15 Inner bend
16 Second spring section
17 Outer bend
18 Third spring section
19 Connecting section
20 Upper side of the S-shaped spring arm
21 Lower side of the S-shaped spring arm
22 Side surfaces of the S-shaped spring arm
23 Center of the cross-sectional area
a Distance
b Distance
m Centerline
DM Torsion spring centerline
M Center point
α Angle
β Angle
r Radius

What is claimed is:

1. A plane torsion spring, in particular for a series-elastic actuator, having an inner fastening point, at least two outer fastening points and at least two spring arms, each of which connects the inner fastening point to one of the outer fastening points in a spring-elastic manner, the spring arms having a similar contour and extending symmetrically, preferably point-symmetrically, with respect to the inner fastening point, and
wherein the spring arms have an S-shaped profile.

2. The plane torsion spring according to claim 1,
wherein the torsion spring has two spring arms.

3. The plane torsion spring according to claim 1, wherein a torsion spring centerline is provided which extends as a straight line through an outer fastening point and a center point of the torsion spring, wherein the S-shaped spring arms each have an inner arc adjacent the inner fastening point and an outer arc adjacent the outer fastening point, and wherein the length of a distance of the outer contour of the inner arc relative to the torsion spring centerline and the length of a distance of the outer contour of the outer arc relative to the torsion spring centerline differ by less than 20%.

4. The plane torsion spring according to claim 1,
wherein the S-shaped spring arms have, starting from a wide connecting section adjacent to the inner fastening point, a first spring section tapering in width, followed by a second spring section widening in width and followed by a third spring section tapering in width, the third spring sections being adjacent to the outer fastening points.

5. The plane torsion spring according to claim 4,
wherein the extension of a centerline of the wide connecting sections of the S-shaped spring arms has an angle in the range from 35° to 55° at the point of intersection with a torsion spring centerline through an outer fastening point.

6. The plane torsion spring according to claim 4,
wherein the extension of a centerline of the third tapered spring sections adjacent to the outer fastening points has an angle in the range from 80° to 100° at the intersection with the torsion spring centerline through an outer fastening point.

7. The plane torsion spring according to claim 1,
wherein the spring sections which have a similar radial distance to the center of the torsion spring as the outer fastening points have a smaller width, wherein the area with the smallest width preferably is at the smallest radial distance to the outer fastening point.

8. The plane torsion spring according to claim 1,
wherein the plane torsion spring is produced by means of an injection molding process.

9. The plane torsion spring according to claim 8,
wherein the plane torsion spring is made of amorphous metal.

10. The plane torsion spring according to claim 1,
wherein the S-shaped spring arms have a varying thickness between the inner fastening point and the outer fastening point.

11. The plane torsion spring according to claim 1,
wherein at least one of an upper side and a lower side of the S-shaped spring arm has an indentation.

12. The plane torsion spring according to claim 1,
wherein a side surface of the S-shaped spring arm has a bulge.

13. The plane torsion spring according to claim 1,
wherein the inner fastening point has an angular receptacle, preferably a square mount rounded at the corners.

14. The plane torsion spring according to claim 1,
wherein the outer fastening point is rotatably pivoted, preferably by a needle bearing.

15. A series-elastic actuator with an electric drive and a plane torsion spring according to claim 1.

16. The series-elastic actuator according to claim 15,
wherein the inner fastening point of the plane torsion spring is fixedly coupled to the electric drive and the outer fastening points of the plane torsion spring are rotatably coupled with respect to an actuated element.

17. A manufacturing method for a plane torsion spring, in particular for a series-elastic actuator, according to claim 1, comprising the steps of:
providing an injection mold for the plane torsion spring,
injecting a material suitable for injection molding into the injection mold,
cooling the injection mold and the injection-molded plane torsion spring, removing the plane torsion spring made of injection-moldable material from the injection mold, and:
machining the plane torsion spring to remove sprue residues and mold seams and to deburr and round off edges; and
machining the plane torsion spring to straighten surfaces, so that surfaces that are subject to a demolding angle are straightened to such an extent that the surfaces can serve as seats for a square holder or a bearing.

18. The plane torsion spring according to claim 3, wherein the length of the distance of the outer contour of the inner arc relative to the torsion spring centerline and the length of the distance of the outer contour of the outer arc relative to the torsion spring centerline differ by less than 10%.

19. The plane torsion spring according to claim 13, wherein the angular receptacle includes a square mount that is rounded at the corners.

20. The manufacturing method as set forth in claim 17, wherein the material is an amorphous metal or a plastic material.
